(19) United States
(12) Patent Application Publication
(10) Pub. No.: US 2008/0155132 A1
(43) Pub. Date: Jun. 26, 2008

(54) Device connecting method, information apparatus, and device connecting program recording medium

(75) Inventors: Katsutoshi Kato, Tokyo (JP); Kouichi Yata, Tokyo (JP); Yasuyo Jitsuishi, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/976,824

(22) Filed: Oct. 29, 2007

(30) Foreign Application Priority Data
Dec. 22, 2006 (JP) 2006-346444

(51) Int. Cl. G06F 3/00

(52) U.S. Cl. 710/16

(57) ABSTRACT

According to one embodiment, plural devices of a model supported by a device driver installed in a personal computer are automatically associated with one wireless communication port. Accordingly, even when various devices exist within a range capable of Bluetooth communication, for example, when a user newly places a portable printer around the personal computer, the user can perform a printing job without making complicated setting such as generation/switching of the wireless communication port or installation of a new device driver.

### CROSS-REFERENCE TO RELATED APPLICATIONS

This application is based upon and claims the benefit of priority from Japanese Patent Application No. 2006-346444, filed Dec. 12, 2006, the entire contents of which are incorporated herein by reference.

### BACKGROUND

1. Field

One embodiment of the invention relates to a device connecting method, an information apparatus, and a device connecting program recording medium.

2. Description of the Related Art

A technique of connecting various devices such as a printer, a fax machine, and a modem to an information apparatus such as a personal computer by a wireless communication system such as Bluetooth (registered trademark) is known. In connecting each of the various devices, a driver (device driver) supporting the device is incorporated in the information apparatus. The information apparatus outputs output data to the device side via a virtual output port created in association with the device driver (See Japanese Patent Application Publication (KOKAI) No. 2004-215164, for example).

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram showing an outline of a function implemented by a device connecting method according to an embodiment of the invention;

FIG. 2 is an exemplary diagram showing another example in FIG. 1 in the embodiment;

FIG. 3 is an exemplary diagram showing a hardware configuration of a personal computer which implements the device connecting method according to the embodiment of the invention;

FIG. 4 is an exemplary diagram showing a software configuration of the personal computer shown in FIG. 3 in the embodiment;

FIG. 5 is an exemplary diagram showing functional components of a wireless communication utility in the embodiment;

FIG. 6 is an exemplary diagram showing an example of information stored in a connection history storage in the embodiment;

FIG. 7 is an exemplary diagram showing an example of device function information in the embodiment;

FIG. 8 is an exemplary diagram showing an example of device attribute information in the embodiment;

FIG. 9 is an exemplary diagram showing an example of information stored in a device driver information storage in the embodiment;

FIG. 10 is an exemplary flowchart showing the operation of the personal computer shown in FIG. 3 in the embodiment;

FIG. 11 is an exemplary flowchart of device automatic selection processing in the embodiment;

FIG. 12 is an exemplary flowchart of one-device selection processing in the embodiment;

FIG. 13 is an exemplary diagram showing an embodiment of a device connecting program recording medium according to the invention; and

FIG. 14 is an exemplary perspective view showing a personal computer to implement a device connecting program stored in the recording medium in the embodiment.

### DETAILED DESCRIPTION

Various embodiments according to the invention will be described hereinafter with reference to the accompanying drawings. In general, according to one embodiment of the invention, this device connecting method includes the steps of: a device retrieving unit retrieving a device existing within a range capable of local wireless communication by an information apparatus; an attribute information acquiring unit acquiring attribute information on the device retrieved by the device retrieving unit from the device; an attribute information judging unit judging whether or not the device is supportable by the device driver based on the attribute information acquired by the attribute information acquiring unit; and, when the device is judged to be supportable by the device driver, an output destination setting unit setting this device as an output destination of an output port.

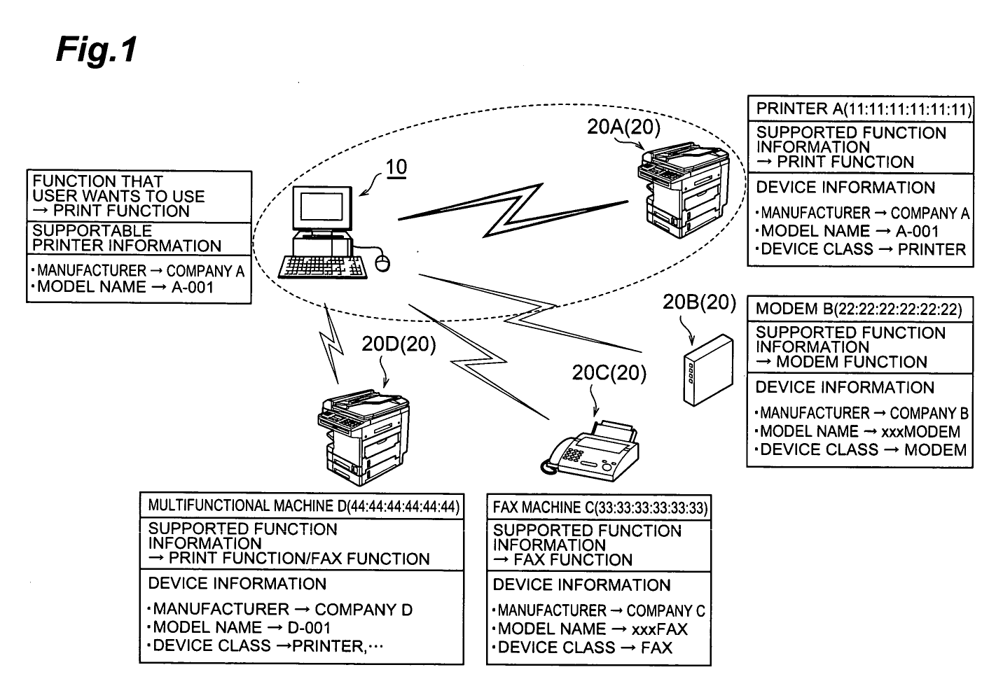

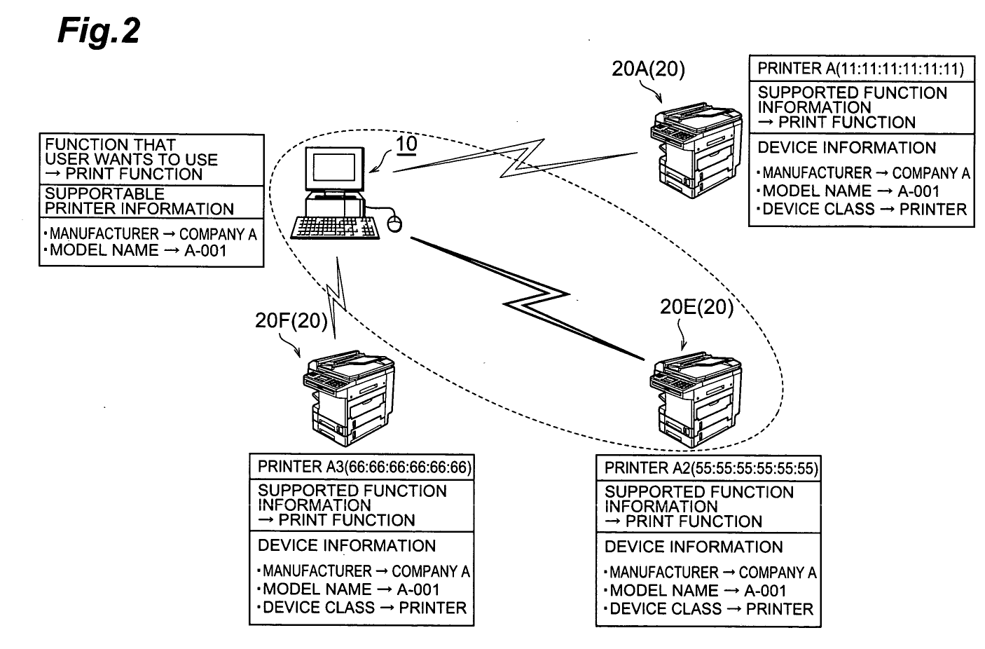

First, an outline of a function implemented by a device connecting method according to an embodiment of the invention will be described with reference to FIG. 1 and FIG. 2.

This function relates to a function of connecting various devices in an information apparatus such as a personal computer. As shown in FIG. 1, for example, a printer 20A, a modem 20B, a fax machine 20C, and a multifunctional machine 20D of a printer/fax machine are placed around the personal computer 10.

The personal computer 10 and the printer 20A, the modem 20B, the fax machine 20C, and the multifunctional machine 20D can communicate information to each other by wireless communication such as Bluetooth. Bluetooth is one of standards for local wireless communication and implements a wireless communication of about 10 m using wireless radio waves of 2.45 GHz band.

Now, for example, when a user tries to print a Web screen which he or she is browsing via the personal computer 10, first, in the personal computer 10, various devices 20 existing within a range capable of Bluetooth communication are retrieved. Then, out of the retrieved devices 20, one device 20 (for example, printer 20A) which supports a print function and is supported by a device driver installed in the personal computer 10 is automatically set as an output destination of printing data (predetermined data) on the Web screen.

Further, when the printer 20A, a printer 20E, and a printer 20F exist around the personal computer 10 and thereby plural devices 20 as candidates for the output destination of the printing data on the Web screen exist as shown in FIG. 2, priorities are assigned to the plural devices. Then, the device 20 with the highest priority (for example, printer F) is automatically set as the output destination of the printing data on the Web screen.

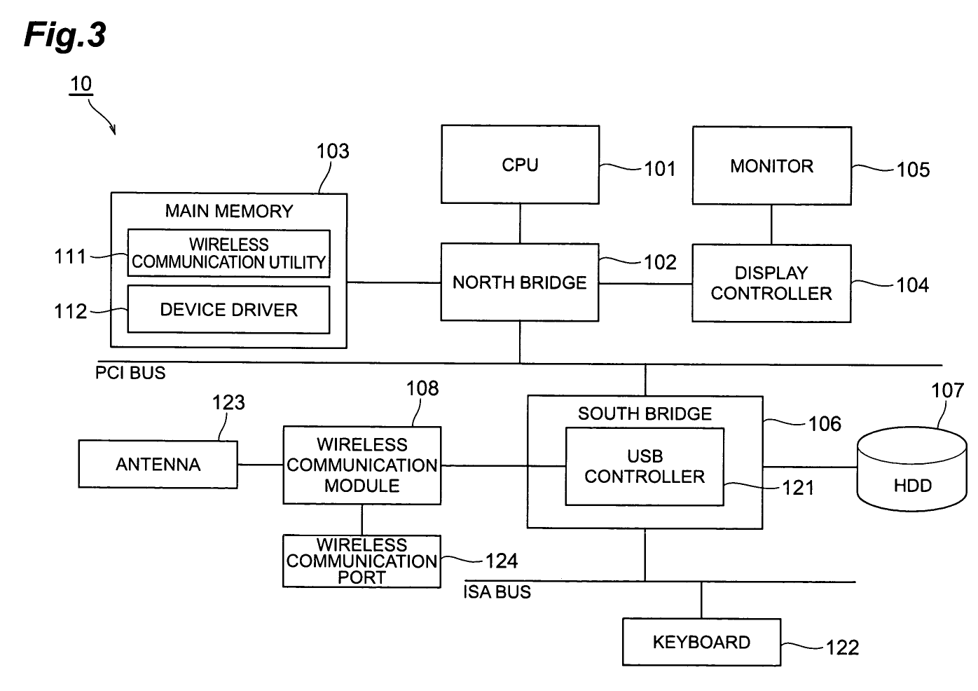

Next, the personal computer 10 having the above function will be described in detail with reference to FIG. 3.

FIG. 3 is a diagram showing the configuration of the personal computer 10 as an example of an information apparatus according to the invention. As shown in this figure, the personal computer 10 includes a CPU 101, a north bridge 102, a main memory 103, a display controller 104, a monitor 105, a south bridge 106, a hard disk drive 107, and a wireless communication module 108.

The CPU 101 is a part which controls the operation of the personal computer 10. The CPU 101 implements an operating system and various application programs read from the hard disk drive 107 into the main memory 103. Further, the CPU 101 implements a wireless communication utility 111 read from the hard disk drive 107 into the main memory 103 and a device driver 112 supporting each of the above various devices 20.

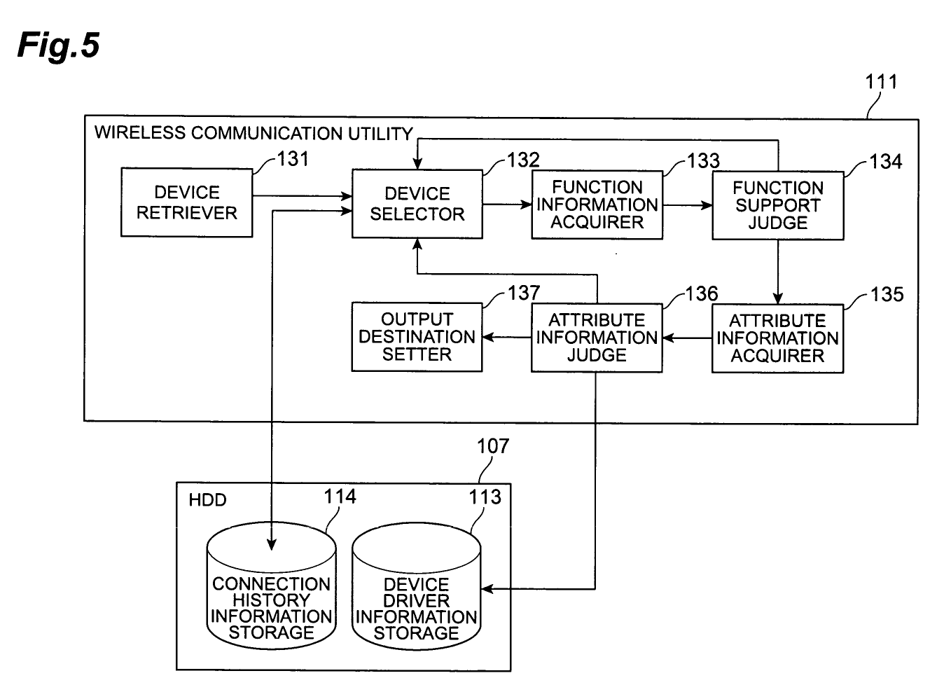

The hard disk drive 107 is a part in which various information is stored. The hard disk drive 107 includes a device driver information storage 113 and a connection history information storage 114 as functional components storing information related to the device connecting method in the embodiment (See FIG. 5). Details thereof will be described later.

The north bridge 102 is a bridge device which bidirectionally connects a local bus of the CPU 101 and a PCI bus. The north bridge 102 is configured by a memory controller, a cache controller, an AGP (Accelerated Graphics Port) controller, and so on (not shown). The display controller 104 is a part which controls an image displayed on the monitor 105.

On the other hand, the south bridge 106 is a bridge device which bidirectionally connects the PCI bus and an ISA bus. The south bridge 106 is configured by an IDE (Integrated Device Electronics) controller, an interrupt controller, a DMA (Direct Memory Access) controller, and so on (not shown) in addition to an USB controller 121. A keyboard 122 and the like are connected to the ISA bus.

The wireless communication module 108 is a part which controls wireless communication by Bluetooth. The wireless communication module 108 includes a RF (Radio Frequency) unit, a baseband unit, and so on (not shown) in addition to an antenna 123. The RF unit up-converts an intermediate frequency to a RF frequency and down-converts the RF frequency to the intermediate frequency. The baseband unit modulates/demodulates radio signals transmitted and received between the personal computer 10 and the device 20 in accordance with a predetermined wireless communication protocol.

A virtual wireless communication port (Btport) 124 which supports Bluetooth is assigned to the wireless communication module 108. The wireless communication module 108 transmits and receives the radio signals between the personal computer 10 and the device 20 via the antenna 123 by executing a command inputted from the CPU 101 via the USB controller 121 in the south bridge 106.

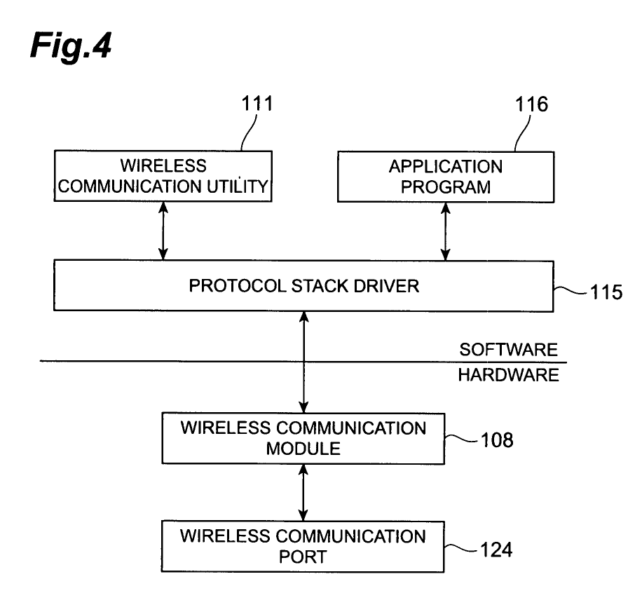

Next, a software configuration to control the operation of the wireless communication module 108 will be described with reference to FIG. 4 and FIG. 5.

Software regarding the operation of the wireless communication module is configured by a protocol stack driver 115 and an application program 116 in addition to the wireless communication utility 111. The protocol stack driver 115 is a program supporting a protocol stack of Bluetooth. The application program 116 is a program, for example, to transmit and receive data to and from the device 20 via the protocol stack driver 115 using the function of the wireless communication module 108.

The wireless communication utility 111 is a part which controls the operation mode of the wireless communication module 108 via the protocol stack driver 115. As shown in FIG. 5, this wireless communication utility 111 includes a device retriever 131, a device selector 132, a function information acquirer 133, a function support judge 134, an attribute information acquirer 135, an attribute information judge 136, and an output destination setter 137. These respective functions are implemented by causing the personal computer 10 to read a device connecting program.

The device retriever 131 is a part which retrieves the devices 20 existing within a range capable of Bluetooth communication by the personal computer 10. The device retriever 131 transmits a device retrieval request (Inquiry) when a predetermined manipulation of a user who desires to print the Web screen is performed. Then, it receives addresses from the devices 20 which have responded to the device retrieval request.

For example, in the case shown in FIG. 1, it receives four addresses of a printer A (11:11:11:11:11:11), a modem B (22:22:22:22:22:22), a fax machine C (33:33:33:33), and a multifunctional machine D (44:44:44:44:44:44).

Further, for example, in the case shown in FIG. 2, it receives three addresses of the printer A (11:11:11:11:11:11), a printer A2 (55:55:55:55:55:55), and a printer A3 (66:66:66:66:66:66). The device retriever 131 outputs the received addresses to the device, selector 132.

The device selector 132 is a part which selects one device 20 from the devices 20 retrieved by the device retriever 131. When receiving only one address from the device retriever 131, the device selector 132 outputs this address itself to the function information acquirer 133.

Further, when receiving plural addresses from the device retriever 131, the device selector 132 functions as a priority determining unit in the invention. In this case, the device selector 132 determines priorities of the devices 20 having the addresses received from the device retriever 131 based on connection histories stored in the connection history information storage 114.

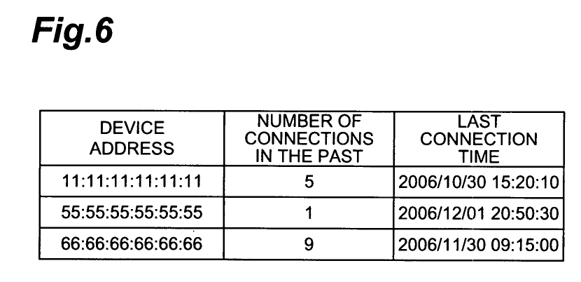

Now, an example of the connection histories stored in the connection history information storage 114 will be shown in FIG. 6. In the example shown in FIG. 6, the addresses “11:11:11:11:11:11/55:55:55:55:55:55/66:66:66 :66:66:66” of the devices 20 connected to the wireless communication port 124 in the past, the numbers of connections in the past “5/1/9”, and the last connection times 2006-10-30 15:20:10/2006-12-01 20:50:30/2006-11-30 09:15:00” are stored in association with one another.

When judging that no device 20 with a history of connection to the wireless communication port 124 exists, for example, the device selector 132 randomly determines the priorities of the plural devices 20 and outputs the address of one device 20 with the highest priority to the function information acquirer 133. Further, when judging that the device 20 with the history of connection to the wireless communication port 124 exists, the device selector 132 judges whether or not there exist plural devices 20 with the connection histories.

When there exists only one device 20 with the connection history, this device 20 is given the highest priority, and the device selector 132 outputs the address of this device 20 to the function information acquirer 133. The priorities of the remaining devices 20 are determined, for example, randomly. On the other hand, when there exist plural devices 20 with the connection histories, the device selector 132 determines the priorities of the plural devices 20 in descending order of the number of times the device 20 has been set as the output destination of the wireless communication port 124, or in ascending order of the difference between a time when the device 20 is last set as the output destination of the wireless communication port 124 and a present time.

When the priorities are determined in descending order of the number of times the device 20 has been set as the output destination of the wireless communication port 124, for example, in the case shown in FIG, 1, only the printer A (11:11:11:11:11:11) has the connection history, so that this printer A is given the highest priority. In the case shown in FIG. 2, the printer A3 with the largest number of connections is given the highest priority although all of the printer A, the printer A2, and the printer A3 have the connection histories. Incidentally, which priority determining condition is selected is previously set, for example, by the user. Then, the device selector 132 outputs the address of the device 20 with the highest priority to the function information acquirer 133.

When receiving judgment result information (described later) from the function support judge 134 after outputting the address, the device selector 132 outputs the address of the device 20 with the second highest priority to the function information acquirer 133. Similarly, when receiving judgment result information (described later) from the attribute information judge 136 after outputting the address, the device selector 132 outputs the address of the device 20 with the second highest priority to the function information acquirer 133.

The function information acquirer 133 is a part which acquires function information from the device 20 retrieved by the device retriever 131. The function information is information indicating a function supported by the device 20. When receiving the address from the device selector 132, the function information acquirer 133 requests the device 20 having this address to transmit function information, receives the function information transmitted from the device 20 in response to the request, and outputs it to the function support judge 134.

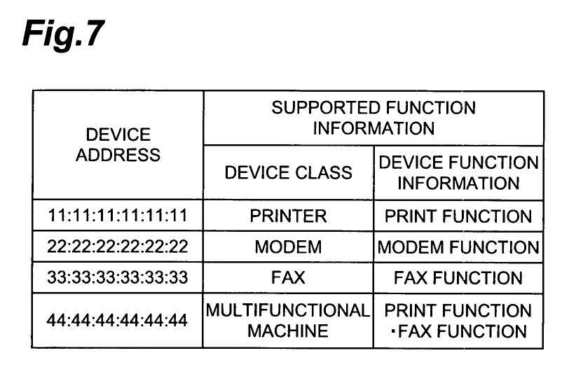

An example of the function information is shown in FIG. 7. In the example shown in FIG. 7, the addresses “11:11:11:11:11:11/22:22:22:22:22:22/33:33:33 :33:33:33/44:44:44:44:44:44” of the devices 20, classes “printer/modem/fax machine/multifunctional machine” of the devices 20, and functions “print function/modem function/fax function/print functione·fax function” of the devices 20 are associated.

The function support judge 134 is a part which judges based on the function information received from the function information acquirer 133 whether or not the device 20 can support output data from the personal computer 10. For example, when printing data is outputted from the personal computer 10, the function support judge 134 judges whether or not the device 20 supports the print function.

When judging that the device 20 is able to support the output data, the function support judge 134 outputs judgment result information to that effect with the address to the attribute information acquirer 135. On the other hand, when judging that the device 20 is unable to support the output data, the function support judge 134 outputs judgment result information to that effect to the device selector 132.

The attribute information acquirer 135 is a part which acquires attribute information from the device 20 judged to be able to support the output data. The attribute information is information, for example, indicating the manufacturer name and model name of the device 20. When receiving the address and the judgment result information from the function support judge 134, the attribute information acquirer 135 requests the device 20 having this address to transmit attribute information, receives the attribute information transmitted from the device 20 in response to the request, and outputs it to the attribute information judge 136.

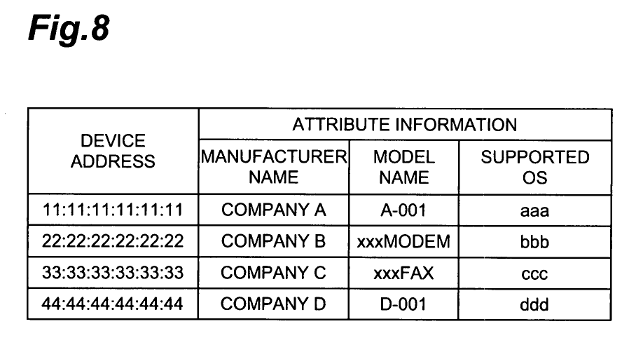

An example of the attribute information is shown in FIG. 8. In the example shown in FIG. 8, the addresses “11:11:11:11:11:11/22:22:22:22:22:22/33:33:33 :33:33:33/44:44:44:44:44:44” of the devices 20, manufacture names “Company A/Company B/Company C/Company D”, model names “A-001/XXXmodem/XXXfax/D-001”, and supported OSs “aaa/bbb/ccc/ddd” are associated.

The attribute information judge 136 is a part which judges based on the attribute information received from the attribute information acquirer 135 whether or not the device 20 is a model supported by the device driver 112 installed in the personal computer 10. When receiving the attribute information from the attribute information acquirer 135, the attribute information judge 136 refers to the device driver information storage 113.

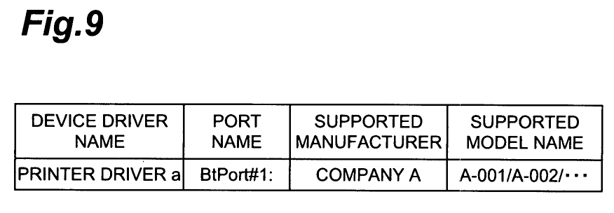

An example of information stored in the device driver information storage 113 is shown in FIG. 9. In the example shown in FIG. 9, the device driver name “printer driver a”, port name “BtPort#1:”, supported manufacturer name “Company A”, and supported model names “A-001/A-002 . . . ” are stored in association with one another. The attribute information judge 136 judges whether or not a manufacturer name and a model name which match the manufacturer name and the model name of the device 20 indicated by the attribute information exist in a list of manufacturer names and model names of devices supported by the device driver 112.

When judging that the device 20 is a model supported by the device driver 112, the attribute information judge 136 outputs judgment result information to that effect with the address to the output destination setter 137. When judging that the device 20 is a model not supported by the device driver 112, the attribute information judge 136 outputs judgment result information to that effect to the device selector 132.

The output destination setter 137 is a part which sets an output destination of data outputted from the wireless communication port 124. When receiving the address and the judgment result information from the attribute information judge 136, the output destination setter 137 sets the device 20 having this address as the output destination of the wireless communication port 124.

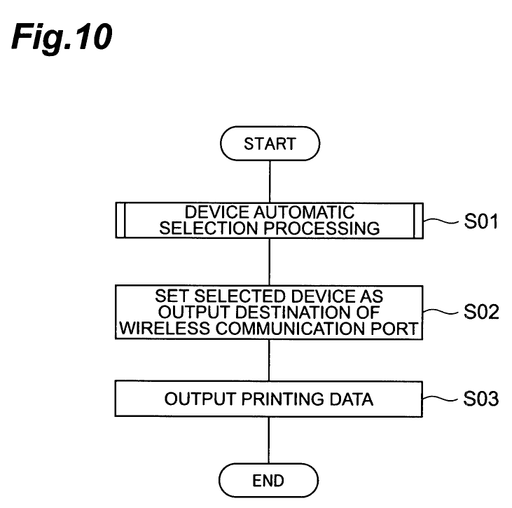

Next, the operation of the personal computer 10 having the above configuration will be described referring to flowcharts shown in FIG. 10 to FIG. 12. Here, the operation when the user tries to print the Web screen of the personal computer 10 will be exemplified.

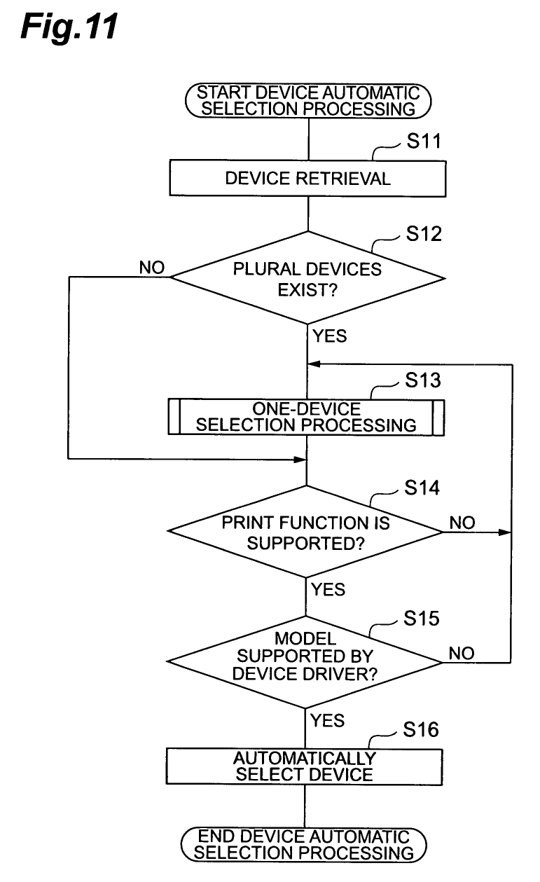

When the predetermined manipulation of the user who desires to print the Web screen is performed, as shown in FIG. 10, first, device automatic selection processing of selecting a device existing around the personal computer 10 is performed (block S01). In this device automatic selection processing, as shown in FIG. 11, first, a device retrieval request is transmitted from the personal computer 10 to the surrounding devices 20, and the devices 20 existing in a range capable of Bluetooth communication are retrieved (block S11).

Then, in the personal computer 10, a judgment whether or not plural devices 20 which have transmitted their addresses in response to the request exist is made (block S12). When only one device 20 has transmitted its address, this device 20 itself is selected, and the processing advances to block S14. When plural devices 20 have transmitted their addresses, one-device selection processing is performed (block S13).

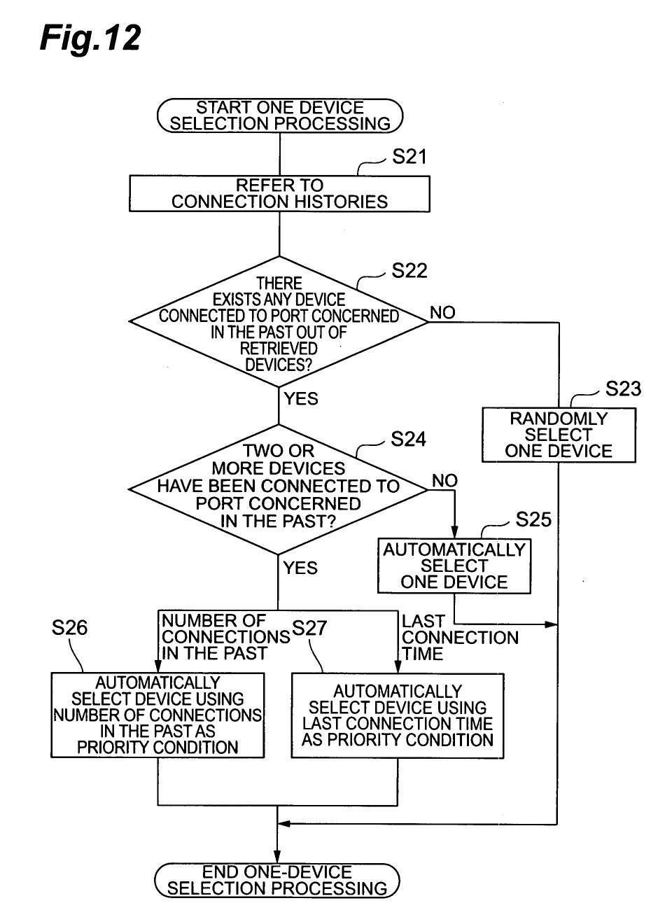

In this one-device selection processing, as shown in FIG. 12, first, the connection histories are referred to (block S21), and a judgment whether or not there exists any device 20 connected to the wireless communication port 124 in the past out of the retrieved devices 20 is made (block S22). When any of the retrieved devices 20 does not have the connection history, for example, one device 20 is randomly selected (block S23), and the one-device selection processing ends.

When the device 20 having the connection history exists, a judgment whether or not there exist a plurality of such devices is made (block S24). When only one device 20 has the connection history, this device 20 is preferentially selected (block S25), and the one-device selection processing ends.

On the other hand, when plural devices 20 have the connection histories, the priorities of the plural devices 20 are determined in accordance with a priority condition, for example, preset by the user. When the priority condition is “the number of times the device 20 has been set as the output destination of the wireless communication port 124”, the device 20 whose number of connections to the wireless communication port 124 in the past is the largest is selected (block S26), and the one-device selection processing ends.

When the priority condition is “the last time of connection to the wireless communication port 124”, the device 20 with the smallest difference between the time when it is last set as the output destination of the wireless communication port 124 and the present time is selected (block S27), and the one-device selection processing ends.

After the one-device selection processing ends, as shown in FIG. 11, the selected device 20 is requested to transmit the function information, and based on the function information transmitted from the device 20 in response to the request, a judgment whether or not the selected device 20 supports the print function is made (block S14).

When the selected device 20 is judged to support the print function, this device 20 is then requested to transmit the attribute information, and based on the attribute information transmitted from the device 20 in response to the request and the information stored in the device driver information storage 113, a judgment whether or not the selected device 20 is a model supported by the device driver 112 installed in the personal computer 110 is made (block S15).

When the selected device 20 is judged to be the model supported by the device driver 112, this device 20 is selected (block S16), and the device automatic selection processing ends. On the other hand, when the selected device 20 is judged not to support the print function in block S14 and when the selected device 20 is judged to be the model not supported by the device driver 112 in block S15, the processing from block S14 to block S16 is repeatedly performed in the order of descending priorities determined in the one-device selection processing.

When the device automatic selection processing ends, as shown in FIG. 10, the selected device 20 is set as the output destination of the wireless communication port 124 (block S02), and the printing data on the Web screen is outputted from the wireless communication port 124 to the selected device 20 (block S03). Incidentally, when no address has been transmitted at the point of the device retrieval in block S11 or when no device 20 supporting the print function and of the model supported by the device driver 112 is selected in the device automatic selection processing, for example, an error display to the effect that no printer is retrieved is made on the monitor 105, and thereafter the processing ends.

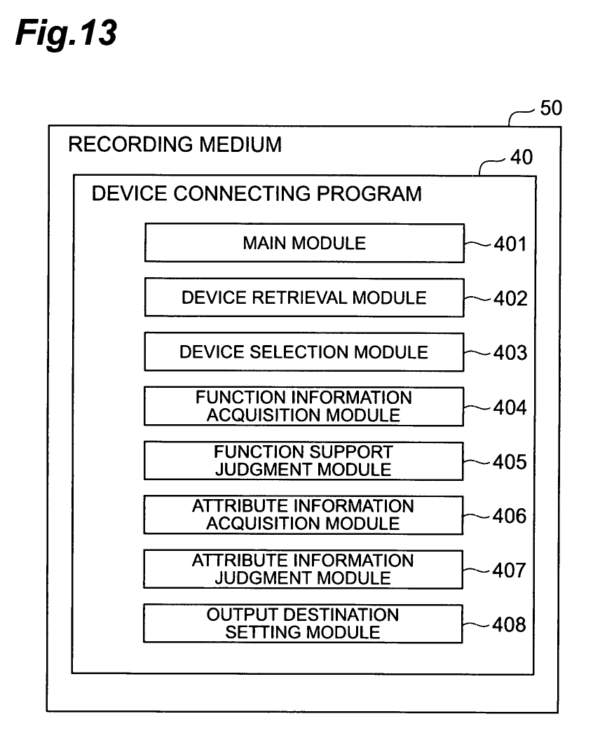

Next, a device connecting program recording medium to allow the personal computer to have the above device connection function will be described. FIG. 13 is a diagram showing the configuration of the device connecting program recording medium.

As shown in FIG. 13, a device connecting program recording medium 50 records a device connecting program 40. The device connecting program 40 includes a main module 401 which controls processing, a device retrieval module 402, a device selection module 403, a function information acquisition module 404, a function support judgment module 405, an attribute information acquisition module 406, an attribute information judgment module 407, and an output destination setting module 408.

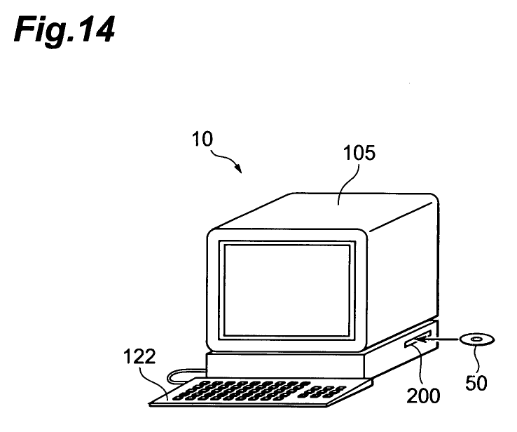

Functions implemented by executing the above respective modules are the same as the respective functional components of the personal computer 10 described above. Namely, the functions of the respective modules of the device connecting program 40 are the same as the functions of the device retriever 131, the device selector 132, the function information acquirer 133, the function support judge 134, the attribute information acquirer 135, the attribute information judge 16, and the output destination setter 137. When the recording medium 50 is inserted into a reader 200 as shown in FIG. 14, the personal computer 10 becomes able to access the device connecting program 40 via the reader 200, and hence becomes operable as an apparatus having the device connection function according to the embodiment.

As described above, according to the device connecting method of the embodiment, when the user tries to print the Web screen, the device 20 existing within the range capable of Bluetooth communication by the personal computer 10 is retrieved. The judgments whether or not the retrieved device 20 supports the print function and whether or not the retrieved device 20 is the model supported by the device driver 112 are made, and one device 20 satisfying the condition is automatically selected and then set as the output destination of the wireless communication port 124.

According to such a device connecting method, instead of associating the wireless communication port 124 in a one-to-one relationship with the device 20 as the output destination, plural devices 20 of the model supported by the device driver 112 installed in the personal computer 10 are automatically associated with one wireless communication port 124. Accordingly, even when various devices 20 exist within the range capable of Bluetooth communication, for example, when the user newly places a portable printer around the personal computer 10, the user can perform a printing job without making complicated setting such as generation/switching of the wireless communication port 124 or installation of a new device driver.

Further, in this device connecting method, priorities are assigned to plural devices 20 based on histories of connection to the wireless communication port 124. The device 20 with the highest priority is automatically set as the output destination of the wireless communication port 124. Further, the condition to determine the priorities is determined arbitrarily by the user's setting in descending order of the number of times the device 20 has been set as the output destination of the wireless communication port 124, or in ascending order of the difference between the time when the device 20 is last set as the output destination of the wireless communication port 124 and the present time.

Consequently, even when plural devices 20 as candidates for the output destination of the printing data exist (See FIG. 2), according to the usage trends of the devices 20 by the user, the appropriate device 20 is automatically set as the output destination of the wireless communication port 124, which can realize a more user-friendly printing job.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A device connecting method of connecting an information apparatus including an output port associated with a device driver and a device as an output destination of data outputted from the information apparatus via the output port by local wireless communication, the device connecting method comprising the steps of:
a device retrieving unit retrieving a device existing within a range capable of the local wireless communication by the information apparatus;
an attribute information acquiring unit acquiring attribute information on the device retrieved by the device retrieving unit from the device;
an attribute information judging unit judging whether or not the device is supported by the device driver based on the attribute information acquired by the attribute information acquiring unit; and
when the device is judged to be supported by the device driver, an output destination setting unit setting this device as the output destination of the output port.

2. The device connecting method according to claim 1, further comprising the steps of:
a function information acquiring unit acquiring function information indicating a function supportable by the device retrieved by the device retrieving unit from the device; and
a function support judging unit judging whether or not the device is allowed to support the data based on the function information acquired by the function information acquiring unit; wherein the attribute information acquiring unit acquires the attribute information from the device judged to be allowed to support the data.

3. The device connecting method according to claim 1, further comprising the steps of:
a connection history storing unit storing a history which tells that the device is set as the output destination of the output port; and
when plural devices are retrieved by the device retrieving unit, a priority determining unit determining priorities of the plural devices based on the history stored in the connection history storing unit, wherein
the attribute information acquiring unit acquires the attribute information from a device with the highest priority out of the plural devices.

4. The device connecting method according to claim 1, wherein a model name of the device is included in the attribute information.

5. The device connecting method according to claim 3, wherein the priority determining unit determines the priorities of the plural devices in descending order of a number of times the device has been set as the output destination of the output port.

6. The device connecting method according to claim 3, wherein the priority determining unit determines the priorities of the plural devices in ascending order of a difference between a time when the device is last set as the output destination of the output port and a present time.

7. An information apparatus including an output port associated with a device driver and allowed to connect a device as an output destination of data outputted via the output port thereto by local wireless communication, the information apparatus comprising:
a device retrieving unit which retrieves a device existing within a range capable of the local wireless communication;
an attribute information acquiring unit which acquires attribute information on the device retrieved by said device retrieving unit from the device;
an attribute information judging unit which judges whether or not the device is supported by the device driver based on the attribute information acquired by said attribute information acquiring unit; and
an output destination setting unit which, when the device is judged to be supported by the device driver, sets this device as the output destination of the output port.

8. A computer-readable device connecting program recording medium used in an information apparatus including an output port associated with a device driver and allowed to connect a device as an output destination of data outputted via the output port thereto by local wireless communication, the device connecting program recording medium on which recorded is a device connecting program for causing the information apparatus to function as:
a device retrieving unit which retrieves a device existing within a range capable of the local wireless communication;
an attribute information acquiring unit which acquires attribute information on the device retrieved by the device retrieving unit from the device;
an attribute information judging unit which judges whether or not the device is supported by the device driver based on the attribute information acquired by the attribute information acquiring unit; and
an output destination setting unit which, when the device is judged to be supported by the device driver, sets this device as the output destination of the output port.
